(19) United States
(12) Patent Application Publication
(10) Pub. No.: US 2004/0155135 A1
(43) Pub. Date: Aug. 12, 2004

(54) Tape cartridge leader for single reel tape cartridges having improved connection performance

(76) Inventor: David T. Hoge, Westminster, CO (US)

Correspondence Address: PATTON BOGGS, 1660 LINCOLN ST, SUITE 2050, DENVER, CO, 80264, US

(21) Appl. No.: 10/359,849

(22) Filed: Feb. 7, 2003

(51) Int. Cl. G11B 23/107

(52) U.S. Cl. 242/348.2

(57) ABSTRACT

The present tape cartridge leader for single reel tape cartridges having improved connection performance includes an ovular aperture for mating with the take-up leader stem and tab. The ovular aperture comprises a stem and tab receiving aperture and a tab receiver segment wherein the tab receiver segment has a longitudinal length substantially greater than 0.15 inches.

### FIELD OF THE INVENTION

The invention relates to digital tape cartridges, and in particular, to a tape cartridge leader having improved performance characteristics for use in single reel tape cartridges.

### PROBLEMS

It is a problem in single reel magnetic tape cartridges to provide a tape cartridge leader that reliably buckles and unbuckles the take-up leader with the tape cartridge leader. Present solutions to this problem suffer from tape cartridge leader and take-up leader connection failures when the tape cartridge is inserted into the tape drive.

Digital data is stored by tape drives on to magnetic tape media utilizing a variety of tape cartridge and tape cassette designs, but in all cases, the magnetic tape media is wound between a pair of tape reels as data is transferred to or from the magnetic tape media. In the art of data storage, the physical space required to store data is an important concern. To conserve space, tape drives often use the single reel tape cartridge design shown in FIG. 1, which utilizes a supply reel 113 located within a removable tape cartridge 102 and a take-up reel 108 located within the tape drive 100.

After the tape cartridge 102 is inserted into the tape drive 100, the magnetic tape media must be loaded into the tape drive 100. The loading operation includes connecting the magnetic tape media to the take-up reel 108 and winding the magnetic tape media to a start point or read position adjacent a tape head 101. Various methods have been employed to make this connection. FIG. 2 illustrates one such method wherein the magnetic tape media connects to the take-up reel 108 via a buckle 200 between a tape cartridge leader 203 and a take-up leader 201. The tape cartridge leader 203 terminates the magnetic tape media at one end and consists of a strong flexible plastic strip that includes an ovular aperture 202 configured to mate with the take-up leader 201. The take-up leader 201 is a similar strong flexible plastic strip that attaches at one end to the take-up reel 108. The opposing end includes a stem 204 and a tab 205 designed to buckle with the ovular aperture 202 on the tape cartridge leader 203.

The tape media is connected to the take-up reel via a buckle between the tape cartridge leader 203 and the take-up leader 201. Unfortunately, buckle failures that cause the tape drive to malfunction can occur during the loading of the tape cartridge. Connection failures occur in different forms. One form of connection failure is a complete miss between the take-up leader 201 and the tape cartridge leader 203. When a complete miss failure occurs, the take-up leader is pulled into the tape drive by the take-up reel and cannot be pushed back into position of loading of subsequent tape cartridges. The tape drive is rendered inoperable and must be removed from its' enclosure for service. Another form of connection failure is known in the art as a “partial buckle”. During a partial buckle only one corner of the tab 205 seats in the aperture 202 of the tape cartridge leader 201. In this case, the tape drive will proceed to wind the tape media to the read position. If the partial buckle disconnects during winding, the take-up leader 201 is pulled into the tape drive as described above resulting in a connection failure.

There are problems with the present design of the tape cartridge leader 203 causing failure of the tape cartridge leader 203 and the take-up leader 201 to buckle when the tape cartridge is inserted into the tape drive 100. A known failure results from the size and shape of ovular aperture 202 in the tape cartridge leader 203. Referring to the prior art tape cartridge leader ovular aperture 202 of FIG. 3 and prior art take-up leader of FIG. 4, the ovular aperture 202 is shaped to conform to the shape of the take-up leader 308 stem 304 and tab 305 by using a radius of curvature for the leading edge 217 of the tab receiving segment 212 which matches the radius 309 of the tab 305 of take-up leader stem and tab leader segment 308. This increases the engagement surface when the take-up leader tab 305 engages with the tab receiver segment 212 of the tape cartridge leader ovular aperture 202. However, a problem occurs when the tab 305 fails to engage with tab receiver segment 212.

When the tape cartridge is inserted into the tape drive 100, the ovular aperture 202 of tape cartridge leader 203 is positioned to connect with stem 204 and tab 205 on take-up leader 201 as illustrated in FIG. 5 in conjunction with FIG. 1. Positioning lever 111 positions take-up leader 201 and tape cartridge leader 203 for connection. In the load position, catch 109 is hooked through aperture 206 and positioning lever 111 holds take-up leader 201 so that stem 204 and tab 205 pass through ovular aperture 202 when tape cartridge 102 is fully inserted into tape drive 100. The loading of tape cartridge 102 engages cartridge present switch 114. Microprocessor 115 in response to a signal from cartridge present switch 114 initiates the connection of take-up leader 300 and tape cartridge leader 310.

During loading, catch 111 is rotated, pulling the stem 204 and tab 205 through ovular aperture 202 toward tab receiver segment 212. If tab 205 passes through stem and tab receiving aperture 219 prior to tab 205 engaging with tab receiver segment 212, the take-up leader and tape cartridge leader connection is not complete. In other words, the tab 205 of take-up leader 201 fails to engage with the leading edge 217 of the tab receiver segment 212 which results in a failed buckle between the tape cartridge leader 203 and take-up leader 201. Instead, the tab 205 passes back through the stem and tab receiving aperture 219 before the tab 205 engages with the leading edge 217 of the tab receiver segment 212. If a proper connection is not made, take-up leader 201 remains connected to catch 109 and is reset for subsequent loading when catch 109 is rotated back to load position 116 from loaded position 110.

For this reason, a need exists for a tape cartridge leader having an ovular aperture wherein the leading edge of the tab receiving segment engages with the leading edge of the tab on the take-up leader before the take-up leader stem and tab passes back through the stem and tab receiving aperture.

### SUMMARY

The present tape cartridge leader for single reel tape cartridges having improved connection performance includes an ovular aperture for mating with the take-up leader stem and tab. The ovular aperture comprises a stem and tab receiving aperture and a tab receiver segment wherein the tab receiver segment has a longitudinal length substantially greater than 0.15 inches. Tests results indicate that a longitudinal length substantially greater than 0.15 inches provides produced improved connection performance.

### BRIEF DESCRIPTION OF THE DRAWINGS

FIG. 1 illustrates an example of a single reel tape cartridge that could incorporate the present tape cartridge leader for single reel tape cartridges having improved connection performance;

FIG. 2 illustrates an example of a prior art tape cartridge leader connected to a take-up leader;

FIG. 3 illustrates a front view of the prior art tape cartridge leader ovular aperture;

FIG. 4 illustrates a front view of the prior art take-up leader stem and tab;

FIG. 5 illustrates an exploded perspective view of the prior art tape cartridge leader positioned to connect with the take-up leader;

FIG. 6 illustrates a tape cartridge leader according to the present invention for connection with a take-up leader;

FIG. 7 illustrates a front view of the take-up leader ovular aperture;

FIG. 8 illustrates an exploded perspective view of the present tape cartridge leader positioned to connect with the take-up leader; and

FIG. 9 illustrates a flow diagram of the operation of the tape drive for connection of the tape cartridge leader with the take-up leader.

### DETAILED DESCRIPTION

The tape cartridge leader for single reel tape cartridges for improved performance summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

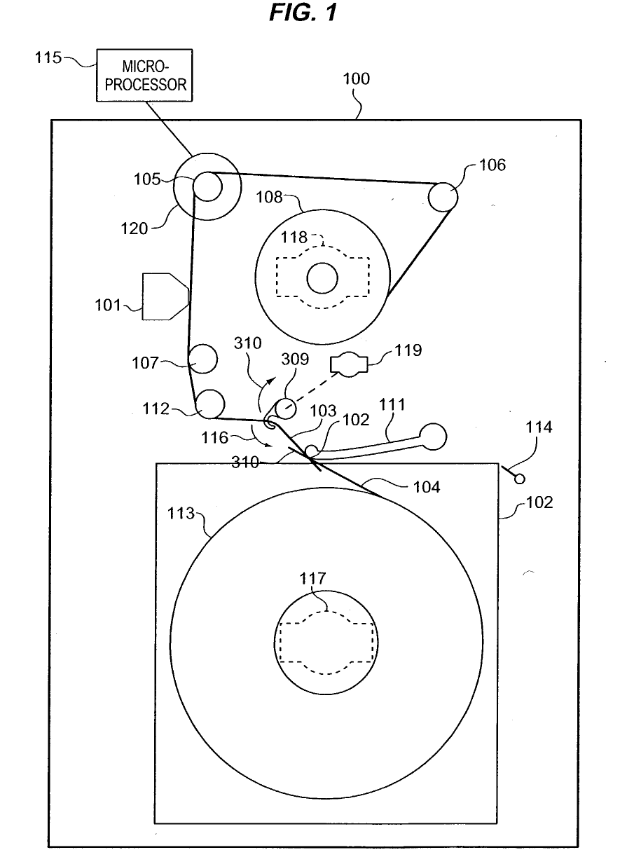

Tape Drive Structure—FIG. 1:

FIG. 1 illustrates a tape drive 100 including a tape cartridge 102 and embodying the tape cartridge leader of the present invention. The tape drive 100 comprises a take-up reel 108, a rotating catch 109, a tape path, a tape head 101, and a positioning lever 111. The tape path comprises guide rollers 106, 105, 107, and 112. The tape cartridge 102 houses the magnetic tape media 104 wound around the supply reel 113. The magnetic tape media 104 includes a tape cartridge leader 101 connected to its free end. The take-up reel 108 includes the take-up leader 103 according to the present invention. The take-up leader 103 connects to the take-up reel 308 and winds around the guide rollers 105, 106, 107, and 112 where it hooks on the catch 109.

Leader Connection—FIGS. 1-3 and 6:

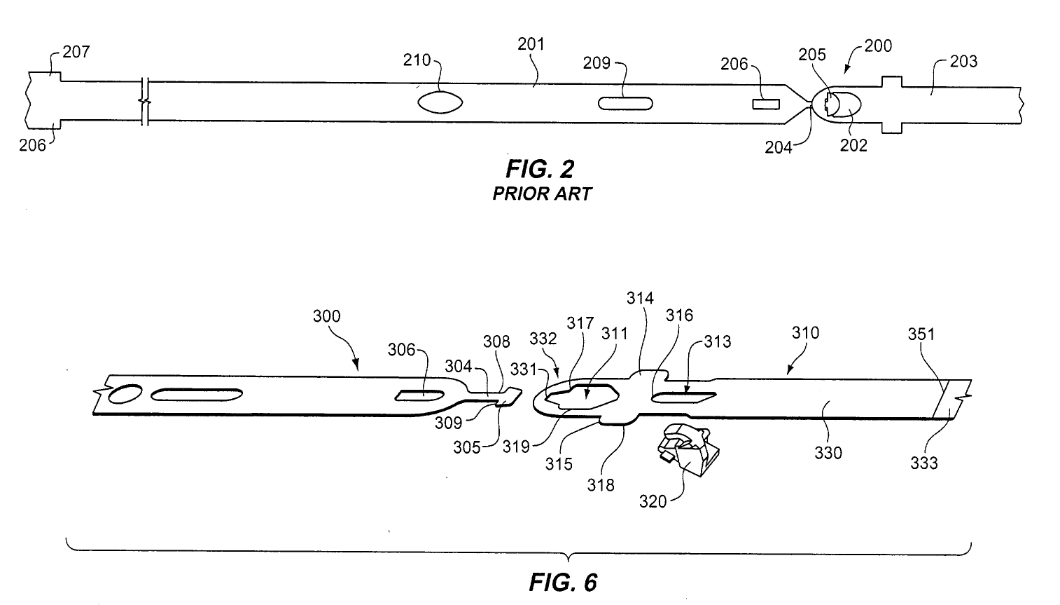

FIG. 2 depicts an example of a take-up leader according to the prior art, the take-up leader 201 includes apertures 209, 210 and 208. When a tape cartridge is not present in the tape drive 100, the take-up leader 201 is wound around a plurality of guide rollers 105-107 and 112 in a curvilinear tape path and is secured in place by a rotating catch 109 that extends through the aperture 208. During operation of the tape drive 100, the catch 109 is rotated to an out of the way position to enable the tape drive to wind the magnetic tape media between the take-up reel 108 and the supply reel 113 in the tape cartridge 102. In similar fashion, the tape cartridge leader 203 consists of a strong flexible plastic strip that includes an ovular aperture 202 that buckles with the stem 204 and tab 205 of the take-up leader 201 of the tape drive.

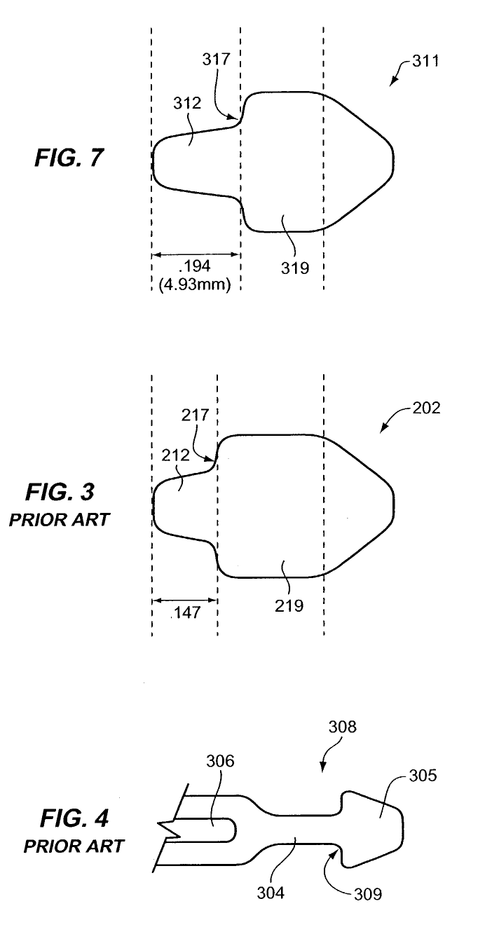

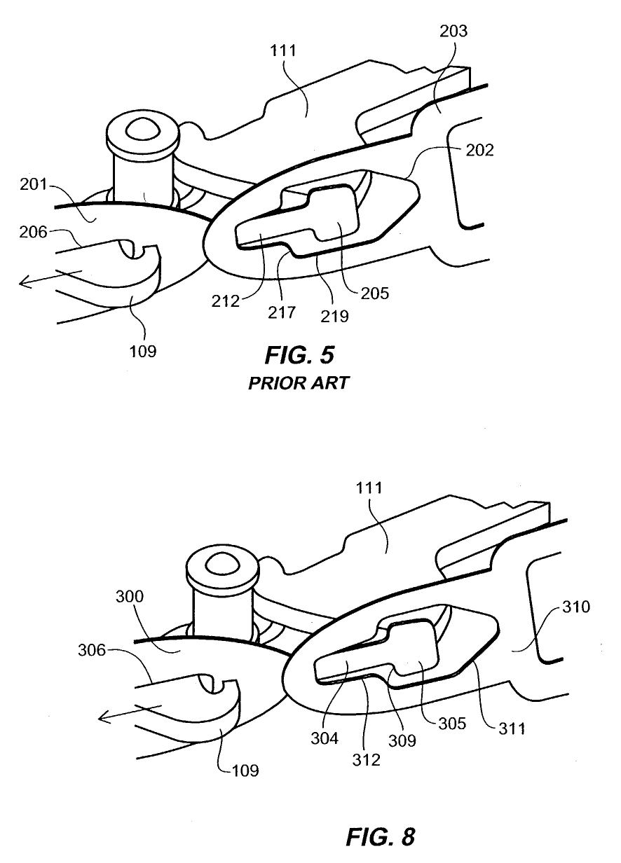

Referring to FIG. 3 in conjunction with FIG. 6, the present tape cartridge leader 310 is similar in design and function to the conventional tape cartridge leader 203 and is configured for use in a conventional tape drive e.g. 100. The tape cartridge leader 310 comprises an elongated main body 330 integrally formed between a first end 331 and a second end 351. The first end 351 connects to the magnetic tape media 333 that is wound on the supply reel in the tape cartridge. The second end 331 includes an ovular aperture 311 that buckles with the stem and tab 308 of the take-up leader 300 of the tape drive.

Tape Cartridge Leader—FIGS. 6 and 7:

The tape cartridge leader ovular aperture 311 comprises two parts: a stem and tab receiving aperture 319 and a tab receiver segment 312. The stem and tab receiving aperture 319 is an opening through which the stem and tab 301 of the take-up leader 300 passes through when the tape cartridge is inserted into the tape drive and the tape cartridge leader 310 is positioned for buckling. The take-up leader 300 is then buckled with the tape cartridge leader 310 by engaging the tab 305 of the take-up leader stem and tab 301 with the tab receiver segment 312, so that the tab 305 of the take-up leader 300 cannot be pulled loose from the tape cartridge leader 310. In the prior art tape cartridge leader of FIG. 3, the tape cartridge leader ovular aperture 202 included a longitudinally elongated stem and tab receiving aperture 219. The length of the cartridge leader ovular aperture 202 is such that the tab 205 of the take-up leader can pass through the cartridge leader ovular aperture 202 prior to engagement of the leading edge 209 of the tab 205 with the leading edge 317 of the tab receiver segment 312, resulting in a connection failure.

The tape cartridge leader 310 has a tab receiver segment 312 with a leading edge 317 at the juncture between the stem and tab receiving aperture 319 and the tab receiver segment 312 to increase the likelihood of the tab 205 engaging with the tab receiver segment 312. In addition, the size of the stem and tab receiving aperture 319 and the tab receiver segment influences the likelihood of a reliable connection of the take-up leader 300 with the tape cartridge leader 310.

Ovular Aperture Dimensional Characteristics—FIGS. 3 and 7:

Referring to the prior art tape cartridge leader ovular aperture 202 of FIG. 3, the longitudinal length of the stem and tab receiving aperture 319 is elongated while the tab receiver segment 212 is shortened to a longitudinal length of approximately 0.147 inches. The elongated stem and tab receiving aperture 219 allows the stem and tab 208 of the take-up leader to pass back through the stem and tab receiving aperture prior to buckling of the tape cartridge leader 203 and the take-up leader 201 when the tape cartridge is inserted into the tape drive. However, the length of the cartridge leader ovular aperture 202 is such that the tab 205 of the take-up leader can pass through the cartridge leader ovular aperture 202 prior to engagement of the leading edge 209 of the tab 205 with the leading edge 217 of the tab receiver segment 212, resulting in a connection failure.

The longitudinal length of the tab receiver segment 312 of the present tape cartridge leader, illustrated in FIG. 7, is substantially greater than 0.15 inches. Since the stem 304 and tab 305 of the take-up leader to pass through the tape cartridge leader ovular aperture 311 during the loading operation, testing alternative tab receiver segment 312 lengths indicates that a tab receiver segment 312 having an lower limit greater that 0.15 results in a more reliable connection of the take-up leader to the tape cartridge leader. However, if the longitudinal length of the tab receiver segment 312 is too long, when the tape cartridge leader is positioned for connection with the take-up leader 300 during a loading operation, tab 305 may impact the opposing end of the ovular aperture 311 such that the tape cartridge leader is not properly. For these reasons, a tab receiver segment having lower limit of 0.15 inches and an upper limit of 0.2 inches results in a reliable positioning of the tape cartridge leader and connection of the take-up leader to the tape cartridge leader when the tape cartridge is inserted into the tape drive.

Decreasing the longitudinal length of the ovular aperture 319 and increasing the length of the tab receiver segment 312 results in the tab 305 of the take-up leader 300 engaging with the leading edge 317 of the tab receiver segment 312 earlier than the prior art. As the tape drive catch 109 rotates to the loaded position, the leading edge 309 of the tab 305 engages with tab receiver segment 312. Engagement of the take-up leader tab 305 with tab receiver segment 312 at an earlier point in time results in a more reliable connection of the take-up leader 300 with the tape cartridge leader 310.

The Loading Operation—FIG. 7:

The magnetic tape media connection operation and the operation of the present tape cartridge leader are described in the flow diagram of FIG. 7 with reference to structures disclosed in FIGS. 1 and 3. Referring first to FIGS. 1 and 3, the tape media loading operation begins when tape cartridge 102 is inserted into tape drive 100. When tape cartridge 102 is fully inserted into tape drive 100, tape cartridge leader 310 is positioned to connect with take-up leader 300. Positioning lever 111 positions tape cartridge leader 310 and take-up leader 300 for connection. In the load position, catch 109 is hooked through aperture 306 and positioning lever 111 holds take-up leader 300 so that stem 304 and tab 305 pass through ovular aperture 311 when tape cartridge 102 is fully inserted into tape drive 100. The loading of tape cartridge 102 engages cartridge present switch 114. Microprocessor 115 in response to a signal from cartridge present switch 114 initiates the connection of take-up leader 300 and tape cartridge leader 310. During loading, take-up leader 300 is sufficiently biased on catch 109 by energizing take-up motor 118 in a clockwise direction to apply torque on catch 109. This prevents take-up leader 300 from releasing even as catch 109 rotates. Take-up leader 300 is not released from catch 109 unless the supply motor 117 and supply reel 113 pull it off in a subsequent step. If a proper connection is not made, take-up leader 300 remains connected to catch 109 and is reset for subsequent loading when catch 109 is rotated back to load position 116 from loaded position 110.

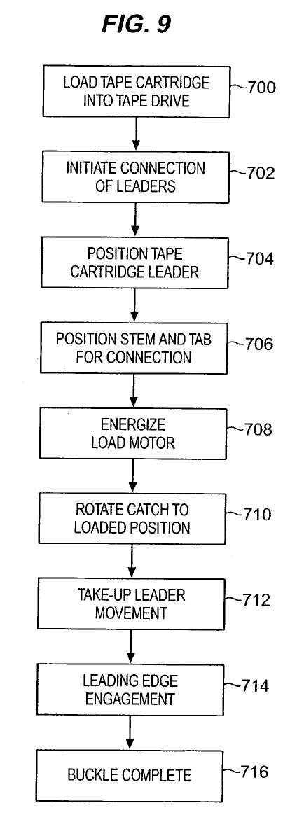

FIG. 9 is a flow diagram of the loading steps for the tape drive 100. Tape cartridge 102 is loaded into tape drive 100 at step 700. Loading tape cartridge 102 engages cartridge present switch 114, which initiates the connection of take-up leader 300 and tape cartridge leader 310 at step 702. As the tape cartridge 102 is inserted into the tape drive 100, the tape cartridge leader 310 is positioned in step 704 for connection with the take-up leader 300. As the tape cartridge leader 310 is positioned in step 704, the take-up leader 300 stem 304 and tab 305 pass through the tape cartridge leader 310 stem and tab receiving aperture 319 in step 706 as illustrated in FIG. 8. For buckling, load motor 119 is energized in step 708 to rotate catch 109 to loaded position 110. It should be noted that the take-up motor 118 is energized sufficiently so that the take-up leader 300 will remain on catch 109 as load motor 119 rotates catch 109 to loaded position 110.

As catch 109 rotates in step 710 to the loaded position 110, take-up leader 300 is pulled toward take-up reel 300. Movement of the take-up leader 300 in step 712 causes the stem 304 and tab 305 of the take-up leader to move toward the tab receiver segment 312 of the stem and tab receiving aperture 319. The further the take-up leader stem 304 and tab 305 is pulled, the closer the tab 305 gets to the tab receiver segment 312 until the leading edge 309 of the tab 305 engages with the leading edge 317 of the tab receiver segment 312 in step 714. Once engaged, tab 305 slides along the tab receiver segment 312 until the tape cartridge leader 310 and the take-up leader 300 are buckled. If a proper connection was made, the torque on supply motor 117 causes the tape cartridge leader 203 to pull the take-up leader 201 off of the catch 109.

Reducing the length of the stem and tab receiving aperture 319 and increasing the length of the tab receiver segment 312 decreases the distance the take-up leader travels prior to leading edge 309 of tab 305 engages with leading edge 317 of tab receiver segment 312. The earlier in the loading process that leading edge 309 of tab 305 engages with leading edge 317 of tab receiver segment 312, the more likely a successful connection between the take-up leader 300 and the tape cartridge leader 310, resulting in a reduction of connection failures when the tape cartridge is inserted into the tape drive.

As to alternative embodiments, those skilled in the art will appreciate that the present tape cartridge leader for single reel tape cartridge having improved connection performance may be implemented with alternative tape cartridge leader ovular aperture and take-up leader stem and tab configurations to allow the tab to engage with the tab receiver segment at an earlier time during the loading operation. Likewise, and alternative position lever and take-up leader catch may be used to position the take-up leader and tape cartridge leader for connection.

It is apparent that there has been described a tape cartridge leader for single reel tape cartridge having improved connection performance that fully satisfies the objects, aims, and advantages set forth above. While the tape cartridge leader for single reel tape cartridge having improved connection performance has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed is:

1. A tape cartridge leader that is connected at one end of a tape media contained in a single reel tape cartridge and detachably connects to a take-up leader when loaded into a single reel tape drive said take-up leader having a stem and a tab, said tape cartridge leader comprising:
a flexible strip connected at one end to said tape media contained within said tape cartridge;
an means within an opposing end of said flexible strip for detachably connecting to said take-up leader in the tape drive when said tape cartridge is loaded into said tape drive, comprising:
a stem and tab receiving aperture for receiving said stem and tab of said take-up leader when said tape cartridge is positioned for connection;
a tab receiver segment having a longitudinal length substantially greater than 0.15 inches for engaging with said tab of said take-up leader.

2. The tape cartridge leader of claim 1 wherein said longitudinal length of said tab receiver segment is less than 0.2 inches.
